(19) United States
(12) Patent Application Publication
(10) Pub. No.: US 2009/0146609 A1
(43) Pub. Date: Jun. 11, 2009

(54) Charging Base with Testing Capability for Medical Device

(76) Inventor: Cesario Dos Santos, Aliso Viejo, CA (US)

Correspondence Address: ALCON, IP LEGAL, TB4-8, 6201 SOUTH FREEWAY, FORT WORTH, TX, 76134, US

(21) Appl. No.: 11/953,580

(22) Filed: Dec. 10, 2007

(51) Int. Cl. H02J 7/02; H02J 7/00

(52) U.S. Cl. 320/111; 320/115

(57) ABSTRACT

A charging base for a battery-operated device has a port with a plurality of contacts and a charging connection. Testing circuitry is coupled to the plurality of contacts, and charging circuitry facilitates the charging connection. A housing at least partially encloses the testing circuitry and the charging circuitry.

### BACKGROUND OF THE INVENTION

The present invention relates to a medical device and more particularly to self testing charging base for a battery powered hand piece.

Several diseases and conditions of the posterior segment of the eye threaten vision. Age related macular degeneration (ARMD), choroidal neovascularization (CNV), retinopathies (e.g., diabetic retinopathy, vitreoretinopathy), retinitis (e.g., cytomegalovirus (CMV) retinitis), uveitis, macular edema, glaucoma, and neuropathies are several examples.

These, and other diseases, can be treated by injecting a drug into the eye. Such injections are typically done manually using a conventional syringe and needle. In using such a syringe, the surgeon is required to pierce the eye tissue with the needle, hold the syringe steady, and actuate the syringe plunger (with or without the help of a nurse) to inject the fluid into the eye. Fluid flow rates are uncontrolled. The volume injected is typically not controlled in an accurate manner because reading the vernier is subject to parallax error. Tissue damage may occur due to an “unsteady” injection.

An effort has been made to control the delivery of small amounts of liquids. A commercially available fluid dispenser is the ULTRA™ positive displacement dispenser available from EFD Inc. of Providence, R.I. The ULTRA dispenser is typically used in the dispensing of small volumes of industrial adhesives. It utilizes a conventional syringe and a custom dispensing tip. The syringe plunger is actuated using an electrical stepper motor and an actuating fluid. Parker Hannifin Corporation of Cleveland, Ohio distributes a small volume liquid dispenser for drug discovery applications made by Aurora Instruments LLC of San Diego, Calif. The Parker/Aurora dispenser utilizes a piezo-electric dispensing mechanism. Ypsomed, Inc. of Switzerland produces a line of injection pens and automated injectors primarily for the self-injection of insulin or hormones by a patient. This product line includes simple disposable pens and electronically-controlled motorized injectors.

U.S. Pat. No. 6,290,690 discloses an ophthalmic system for injecting a viscous fluid (e.g. silicone oil) into the eye while simultaneously aspirating a second viscous fluid (e.g. perflourocarbon liquid) from the eye in a fluid/fluid exchange during surgery to repair a retinal detachment or tear. The system includes a conventional syringe with a plunger. One end of the syringe is fluidly coupled to a source of pneumatic pressure that provides a constant pneumatic pressure to actuate the plunger. The other end of the syringe is fluidly coupled to an infusion cannula via tubing to deliver the viscous fluid to be injected.

It would be desirable to have a portable hand piece for reliably injecting a drug into the eye. Such a portable hand piece can utilize a limited reuse assembly and a disposable tip segment. Maintaining the limited reuse assembly can ensure proper function and avoid patient harm.

### SUMMARY OF THE INVENTION

In one embodiment consistent with the principles of the present invention, the present invention is a charging base for a battery-operated device. The charging base has a port with a plurality of contacts and a charging connection. Testing circuitry is coupled to the plurality of contacts, and charging circuitry facilitates the charging connection. A housing at least partially encloses the testing circuitry and the charging circuitry.

In another embodiment consistent with the principles of the present invention, the present invention is a charging base for a battery-operated medical device. The charging base has a testing port and a charging port. The testing port has a recess and a plurality of contacts. A fuse simulator is coupled to at least one of the plurality of contacts, a temperature simulator circuit is coupled to at least one of the plurality of contacts, and a mechanical linkage interface sensor is located near the recess. The charging port has a charging connection. Charging circuitry is located near the charging port. A housing at least partially encloses the charging circuitry, fuse simulator, temperature simulator circuit, and mechanical linkage interface sensor.

It is to be understood that both the foregoing general description and the following detailed description are exemplary and explanatory only and are intended to provide further explanation of the invention as claimed. The following description, as well as the practice of the invention, set forth and suggest additional advantages and purposes of the invention.

### BRIEF DESCRIPTION OF THE DRAWINGS

The accompanying drawings, which are incorporated in and constitute a part of this specification, illustrate several embodiments of the invention and together with the description, serve to explain the principles of the invention.

FIG. 1 is a cross section view of a disposable tip segment and a limited reuse assembly according to an embodiment of the present invention.

FIG. 2 is a cross section view of a tip segment and limited reuse assembly nested in a charging base.

FIG. 3 is a cross section view of a limited reuse assembly according to an embodiment of the present invention.

FIG. 4 is a cross section view of a limited reuse assembly according to an embodiment of the present invention.

FIG. 5 is an end view of a limited reuse assembly according to the principles of the present invention.

FIG. 6A is a top view of a charging base according to the principles of the present invention.

FIG. 6B is a side cross section view of the charging base of FIG. 6A.

FIG. 6C is a side cross section view of two limited reuse assemblies nested in the charging base of FIG. 6A

FIG. 7A is a top view of a charging base according to the principles of the present invention.

FIG. 7B is a side cross section view of the charging base of FIG. 7A.

FIG. 7C is a side cross section view of a limited reuse assembly nested in a testing configuration in the charging base of FIG. 7A.

FIG. 7D a side cross section view of a limited reuse assembly nested in a charging configuration in the charging base of FIG. 7A.

FIG. 8 is a cross section view of a limited reuse assembly nested in a charging base according to the principles of the present invention.

### DETAILED DESCRIPTION OF THE PREFERRED EMBODIMENTS

Reference is now made in detail to the exemplary embodiments of the invention, examples of which are illustrated in the accompanying drawings. Wherever possible, the same reference numbers are used throughout the drawings to refer to the same or like parts.

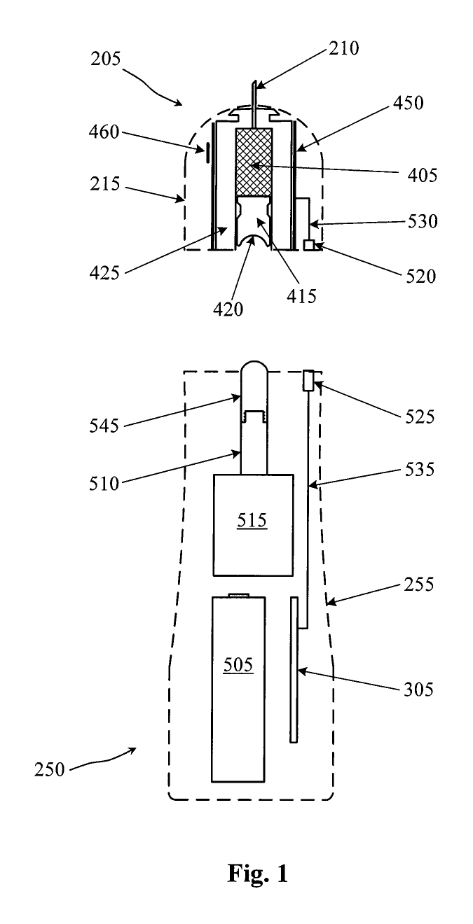

FIG. 1 is a cross section view of a disposable tip segment and a limited reuse assembly according to an embodiment of the present invention. FIG. 1 shows how tip segment 205 interfaces with limited reuse assembly 250. In the embodiment of FIG. 1, tip segment 205 includes plunger interface 420, plunger 415, dispensing chamber housing 425, tip segment housing 215, temperature control device 450, thermal sensor 460, needle 210, dispensing chamber 405, interface 530, and tip interface connector 520. Limited reuse assembly 250 includes mechanical linkage 545, actuator shaft 510, actuator 515, power source 505, controller 305, limited reuse assembly housing 255, interface 535, and limited reuse assembly interface connector 525.

In tip segment 205, plunger interface 420 is located on one end of plunger 415. The other end of plunger 415 forms one end of dispensing chamber 405. Plunger 415 is adapted to slide within dispensing chamber 405. An outer surface of plunger 415 is fluidly sealed to the inner surface of dispensing chamber housing 425. Dispensing chamber housing 425 surrounds the dispensing chamber 405. Typically, dispensing chamber housing 425 has a cylindrical shape. As such, dispensing chamber 405 also has a cylindrical shape.

Needle 210 is fluidly coupled to dispensing chamber 405. In such a case, a substance contained in dispensing chamber 405 can pass through needle 210 and into an eye. Temperature control device 450 at least partially surrounds dispensing chamber housing 425. In this case, temperature control device 450 is adapted to heat and/or cool dispensing chamber housing 425 and any substance contained in dispensing chamber 405. Interface 530 connects temperature control device 450 and thermal sensor 460 with tip interface connector 520.

The components of tip segment 205, including dispensing chamber housing 425, temperature control device 450, and plunger 415 are at least partially enclosed by tip segment housing 215. In one embodiment consistent with the principles of the present invention, plunger 415 is sealed to the interior surface of dispensing chamber housing 425. This seal prevents contamination of any substance contained in dispensing chamber 405. For medical purposes, such a seal is desirable. This seal can be located at any point on plunger 415 or dispensing chamber housing 425.

In limited reuse assembly 250, power source 505 provides power to actuator 515. An interface (not shown) between power source 505 and actuator 515 serves as a conduit for providing power to actuator 515. Actuator 515 is connected to actuator shaft 510. When actuator 515 is a stepper motor, actuator shaft 510 is integral with actuator 515. Mechanical linkage interface 545 is connected to actuator shaft 510. In this configuration, as actuator 515 moves actuator shaft 510 upward toward needle 210 mechanical linkage interface 545 also moves upward toward needle 210.

Controller 305 is connected via interface 535 to limited reuse assembly interface connector 525. Limited reuse assembly interface connector 525 is located on a top surface of limited reuse assembly housing 255 adjacent to mechanical linkage interface 545. In this manner, both limited reuse assembly interface connector 525 and mechanical linkage interface 545 are adapted to be connected with tip interface connector 520 and plunger interface 420 respectively.

Controller 305 and actuator 515 are connected by an interface (not shown). This interface (not shown) allows controller 305 to control the operation of actuator 515. In addition, an interface (not shown) between power source 505 and controller 305 allows controller 305 to control operation of power source of 310. In such a case, controller 305 may control the charging and the discharging of power source 505 when power source 505 is a rechargeable battery.

Controller 305 is typically an integrated circuit with power, input, and output pins capable of performing logic functions. In various embodiments, controller 305 is a targeted device controller. In such a case, controller 305 performs specific control functions targeted to a specific device or component, such as a temperature control device or a power supply. For example, a temperature control device controller has the basic functionality to control a temperature control device. In other embodiments, controller 305 is a microprocessor. In such a case, controller 305 is programmable so that it can function to control more than one component of the device. In other cases, controller 305 is not a programmable microprocessor, but instead is a special purpose controller configured to control different components that perform different functions. While depicted as one component, controller 305 may be made of many different components or integrated circuits.

Tip segment 205 is adapted to mate with or attach to limited reuse assembly 250 as previously described. In the embodiment of FIG. 1, plunger interface 420 located on a bottom surface of plunger 415 is adapted to mate with mechanical linkage interface 545 located near a top surface of limited reuse assembly housing 255. In addition, tip interface connector 520 is adapted to connect with limited reuse assembly interface connector 525. When tip segment 205 is connected to limited reuse assembly 250 in this manner, actuator 515 and actuator shaft 510 are adapted to drive plunger 415 upward toward needle 210. In addition, an interface is formed between controller 305 and temperature control device 450. A signal can pass from controller 305 to temperature control device 450 through interface 535, limited reuse assembly interface connector 525, tip interface connector 520, and interface 530.

In operation, when tip segment 205 is connected to limited reuse assembly 250, controller 305 controls the operation of actuator 515. Actuator 515 is actuated and actuator shaft 510 is moved upward toward needle 210. In turn, mechanical linkage interface 545, which is mated with plunger interface 420, moves plunger 415 upward toward needle 210. A substance located in dispensing chamber 405 is then expelled through needle 210.

In addition, controller 305 controls the operation of temperature control device 450. Temperature control device 450 is adapted to heat and/or cool dispensing chamber housing 425. Since dispensing chamber housing 425 is at least partially thermally conductive, heating or cooling dispensing chamber housing 425 heats or cools a substance located in dispensing chamber 405. Temperature information can be transferred from thermal sensor 460 to controller 305 via any of a number of different interface configurations. This temperature information can be used to control the operation of temperature control device 450. When temperature control device 450 is a heater, controller 305 controls the amount of current that is sent to temperature control device 450. The more current sent to temperature control device 450, the hotter it gets. In such a manner, controller 305 can use a feed back loop utilizing information from thermal sensor 460 to control the operation of temperature control device 450. Any suitable type of control algorithm, such as a proportional integral derivative (PID) algorithm, can be used to control the operation of temperature control device 450.

In various embodiments of the present invention, temperature control device 450 heats a phase transition compound that is located in dispensing chamber 405. This phase transition compound carries a drug that is to be injected into the eye. A phase transition compound is in a solid or semi-solid state at lower temperatures and in a more liquid state at higher temperatures. Such a substance can be heated by temperature control device 450 to a more liquid state and injected into the eye where it forms a bolus that erodes over time. Likewise, a reverse gelation compound may be used. A reverse gelation compound is in a solid or semi-solid state at higher temperatures and in a more liquid state at lower temperatures. Such a compound can be cooled by temperature control device 450 to a more liquid state and injected into the eye where it forms a bolus that erodes over time. As such, temperature control device 450 may be a device that heats a substance in dispensing chamber 405 or a device that cools a substance in dispensing chamber 405 (or a combination of both). After being delivered into the eye, a phase transition compound or reverse gelation compound erodes over time providing a quantity of drug over an extended period of time. Using a phase transition compound or reverse gelation compound provides better drug dosage with fewer injections.

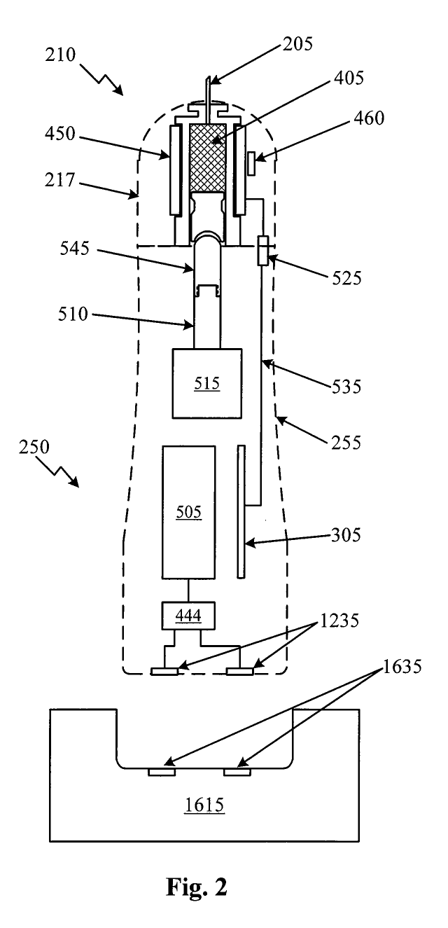

FIG. 2 is a cross section view of a charging base and the limited reuse assembly of FIG. 1 attached to a tip segment. In FIG. 2, a bottom surface of limited reuse assembly 250 interfaces with charging base 1615. When limited reuse assembly 250 is resting in charging base 1615, power source 505 can be charged. After being charged, limited reuse assembly 250 can be removed from charging base 1615. In one embodiment of the present invention, contacts 1635 mate with contacts 1235 to form a connection between charging base 1615 and the medical device (limited reuse assembly 250 and tip segment 210). In one embodiment, contacts 1235 and 1635 are mini-USB connectors. In another embodiment, they are a CradleCon™ connector manufactured by Molex®.

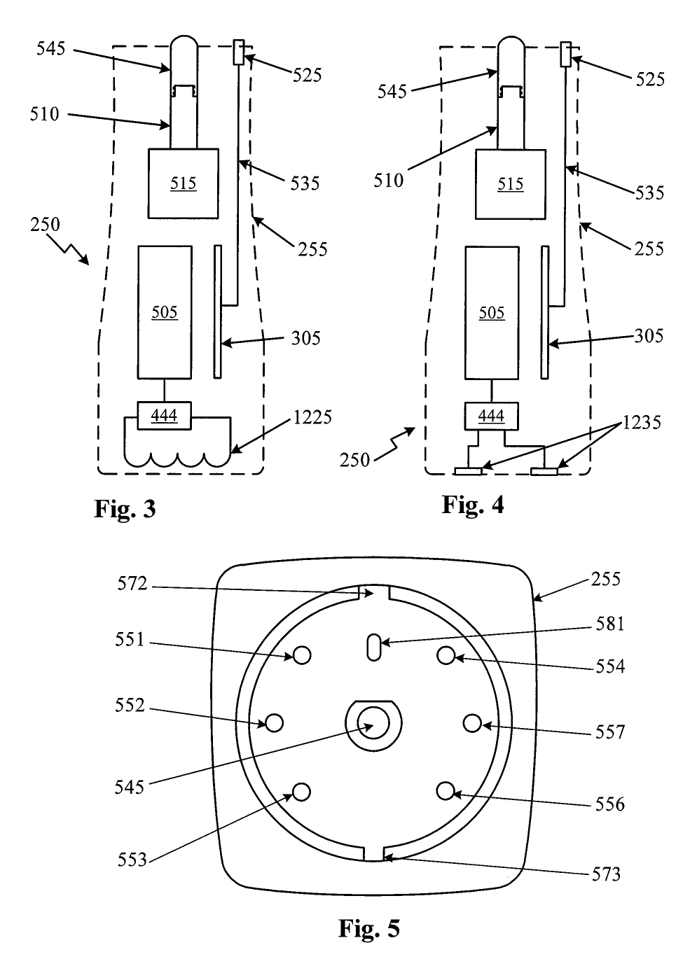

FIG. 3 is a cross section view of a limited reuse assembly according to an embodiment of the present invention. In FIG. 3, limited reuse assembly 250 includes mechanical linkage interface 545, actuator shaft 510, actuator 515, power source 505, controller 305, limited reuse assembly housing 255, interface 535, limited reuse assembly interface connector 525, power source controller 444, and inductive element 1225.

The embodiment of FIG. 3 includes power source controller 444 and inductive element 1225. These two components control the charging of power source 505 when power source 505 is, for example, a rechargeable battery. Power source controller 444 includes circuitry that may perform any of a number of different functions related to the charging, monitoring, and maintenance of power source 505. In other embodiments, power source controller 444 may be implemented in or integrated into controller 305.

In one embodiment of the present invention, power source controller 444 (or controller 305, as the case may be) implements the various algorithms described below. In other embodiments of the present invention power source controller 444 (or controller 305, as the case may be) detects fault conditions or other unsafe conditions of power source 505 and prevents further use of limited reuse assembly 250.

To charge power source 505, a current is induced in inductive element 1225 when it is placed near another inductive element in a charging base (not shown). This induced current charges power source 505.

FIG. 4 is a cross section view of a limited reuse assembly according to an embodiment of the present invention. In FIG. 4, limited reuse assembly 250 includes mechanical linkage interface 545, actuator shaft 510, actuator 515, power source 505, controller 305, limited reuse assembly housing 255, interface 535, limited reuse assembly interface connector 525, power source controller 444, and contacts 1235.

In the embodiment of FIG. 4, contacts 1235 interface with contacts on a charging base (not shown) to provide power to power source 505. In one embodiment, contacts 1235 are a mini-USB connection. In another embodiment, contacts 1235 are a CradleCon™ connector manufactured by Molex®. Other types of connectors may also be used.

FIG. 5 is an end view of a limited reuse assembly according to the principles of the present invention. The end view of the limited reuse assembly depicted in FIG. 5 shows housing 255, mechanical linkage interface 545, limited reuse assembly interface connectors 551, 552, 553, 554, 557, and 556, slots 572 and 573, and alignment pin 581.

In the embodiment of FIG. 5, one end of mechanical linkage interface 545 is not completely circular. It has a flat portion that is designed to align with a plunger interface with a similar cross-sectional shape. This optional feature is designed to allow proper alignment of a tip segment and a limited reuse assembly. In other embodiments of the present invention, the cross section view of one end of mechanical linkage interface 545 is circular.

The embodiment of FIG. 5 also includes an optional alignment slot 581 to assist in properly aligning a tip segment with a limited reuse assembly. Alignment pin 581 interfaces with an alignment slot on a tip segment. In another embodiment of the present invention, slots 572 and 573 have different sizes. Alternatively, slots 572 and 573 may have different shapes. The two slots 572 and 573 also assist in aligning a tip segment with a limited reuse assembly by interfacing with tabs located on a tip segment. These various alignment features may also be used to interface a limited reuse assembly with a charging base.

Connectors 551, 552, 553, 554, 557, and 556 electrically link a tip segment to a limited reuse assembly. Connectors 551, 552, 553, 554, 557, and 556 interface with like connectors on a tip segment. These connectors provide a path for signals to pass between a tip segment and a limited reuse assembly and/or a charging base.

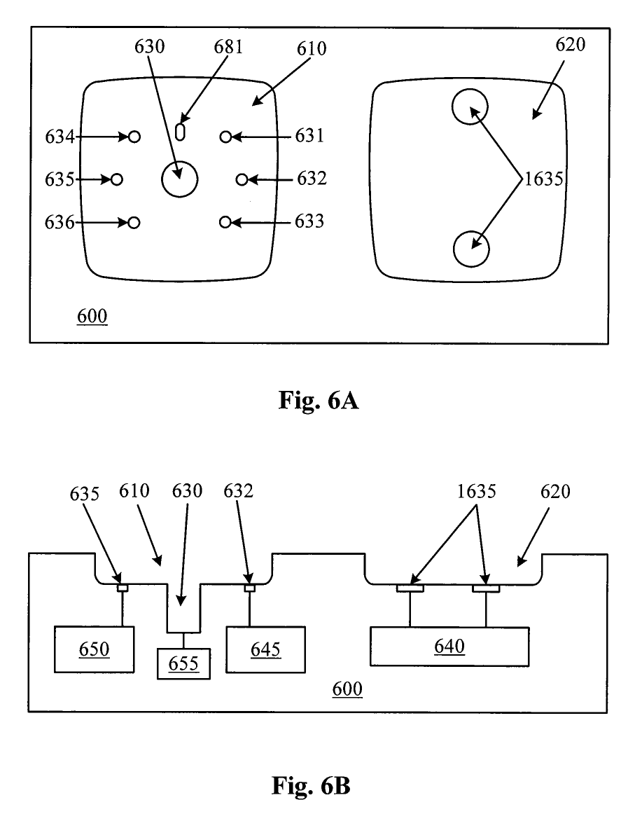

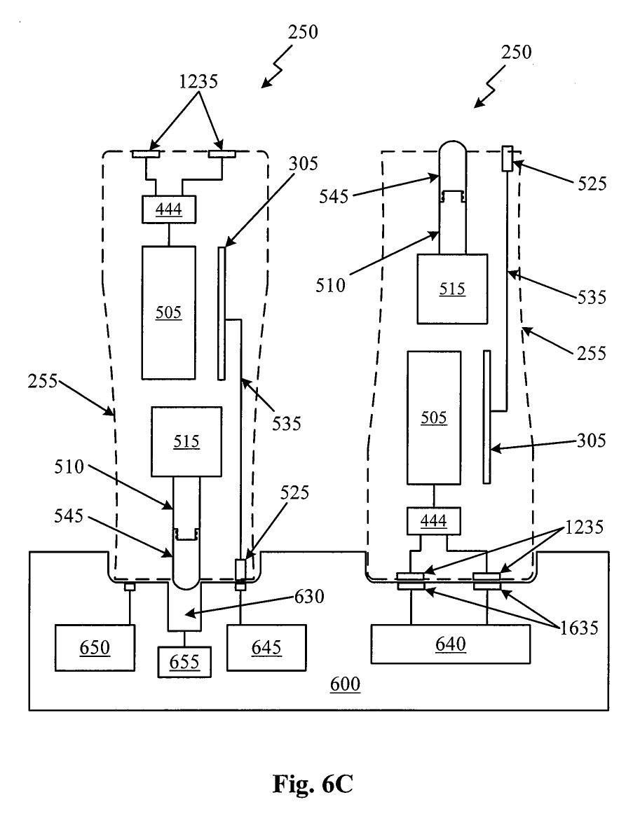

FIG. 6A is a top view of a charging base according to the principles of the present invention. In the embodiment of FIG. 6A, charging base 600 has two ports 610 and 620. Testing port 610 is configured to receive the top end of a limited reuse assembly (such as that depicted in FIG. 5). Testing port 610 has a number of contacts (631, 632, 633, 634, 635, and 636) designed to make an electrical and/or data connection to a limited reuse assembly with like contacts or connection pins. A recess 630 is designed to accommodate mechanical linkage interface 545. An optional alignment pin 681 is designed to interface with the alignment slot on the limited reuse assembly of FIG. 5. Charging port 620 is configured to receive the bottom end of a limited reuse assembly. Charging port 620 includes two charging contacts 1635. Alternatively, charging port 620 may employ an inductive charging method, in which case no contacts are present.

Charging base 600 of FIG. 6A is designed to receive the charging or bottom end of a limited reuse assembly so that it can be charged. Charging base 600 is also designed to receive the top or interface end of limited reuse assembly so that it can be tested prior to use. Testing of the limited reuse assembly (in testing port 610) may occur periodically. In one embodiment, a limited reuse assembly may keep track of its usage and require that a test be performed prior to use. In other embodiments, a test is required after a fixed number of uses or after every use. In any case, the interfacing end of a limited reuse assembly can be placed in testing port 610 so that diagnostic tests can be run to ensure that the limited reuse assembly functions properly. In one case, a limited reuse assembly may be charged first by placing its charging end in charging port 620. After it is fully charged, the interfacing end may be placed in testing port 610 to run a diagnostic test. In other embodiments of the present invention, charging base 600 may be used during the manufacturing process to charge and test a limited reuse assembly before shipment.

While the size and shape of ports 610 and 620 are shown as being the same, in other embodiments of the present invention, they may be different. For example, the interfacing end of a limited reuse assembly may be smaller than the charging end. In such a case testing port 610 is smaller than charging port 620. In another embodiment, the charging end of a limited reuse assembly may have a different shape than the interfacing end. In such a case, testing port 610 has a different shape than charging port 620. The use of different sized and/or shaped ports allows for ease of use and for the proper interface of the limited reuse assembly with charging base 600. If the ports 610, 620 have different shapes, then only one end of a limited reuse assembly may be nested in each port.

FIG. 6B is a side cross section view of the charging base of FIG. 6A. FIG. 6C is a side cross section view of two limited reuse assemblies nested in the charging base of FIG. 6A. In the embodiment of FIGS. 6B and 6C, charging base 600 includes ports 610 and 620, charging contacts 1635, contacts 632 and 635, recess 630, charging circuitry 640, fuse simulator 645, temperature circuit simulator 650, and mechanical linkage interface sensor 655. Charging contacts interface with charging circuitry 640. Contact 632 (or other contacts not depicted) interfaces with fuse simulator 645. Contact 635 (or other contacts not depicted) interfaces with temperature circuit simulator 650. Recess 630 interfaces with mechanical linkage interface sensor 655. While ports 610 and 620 are shown as having the same size and shape, they may have different sizes and/or shapes as previously discussed.

Charging circuitry 640 includes the commonly known electrical and electronic components necessary to transfer power to a limited reuse assembly via charging contacts 1635. Typically, charging contacts 1635 interface with similar contacts 1235 on a limited reuse assembly. The limited reuse assembly typically includes a rechargeable battery 505. Charging circuitry 640 is designed to charge rechargeable battery 505 in a limited reuse assembly. To this end, charging circuitry may contain an AC-DC converter to convert AC line voltage into a low DC voltage suitable for charging a rechargeable battery. Such AC-DC converters are commonly known, typically electronic, and used for charging any of a number of different portable electronic devices such as cell phones. Charging circuitry 640 also typically contains various line filters, surge protection, and the like—also commonly associated with electronic power supplies.

When an inductive charging scheme is used, charging contacts 1635 are not present. Instead, charging circuitry includes one half of a transformer (one inductive coil), and the limited reuse assembly includes the other half of the transformer (one inductive coil). When the two halves (or coils) of the transformer are adjacent to each other (when the limited reuse assembly is nested in the charging base), the two coils are magnetically coupled and power can be transferred to the limited reuse assembly. This inductive scheme of power transfer is commonly known and is used in commercial products such as electric toothbrushes.

Fuse simulator 645 is designed to test whether a limited reuse assembly can recognize the two states of a fuse (blown fuse and in-tact fuse). The fuse simulator, therefore, has two states—an open circuit (blown fuse) and a closed circuit (in-tact fuse). Any type of switch can be used to simulate the two states. An open switch simulates a blown fuse, and a closed switch simulates an in-tact fuse. These two states can be used to test whether the controller 305 in a limited reuse assembly recognizes the two fuse states that may occur in a tip segment. Typically, the fuse in a tip segment is in-tact if the tip segment is ready to be used, and the fuse is blown if the tip segment has already been used (or is not suitable for use). The fuse state simulated by fuse simulator 645 can be communicated to the controller 305 via one or more of the contacts depicted in FIG. 6A. While fuse simulator 645 is depicted in FIG. 6B as interfacing with contact 632, fuse simulator 645 interfaces with any two of the contacts (631, 632, 633, 634, 635, 636) depicted in FIG. 6A.

Temperature circuit simulator 650 is designed to simulate a temperature control device and/or a thermal sensor contained in a tip segment. Temperature circuit simulator includes an electrical equivalent of a temperature control device and/or thermal sensor. For example, when the temperature control device is a heater, temperature circuit simulator 650 is a resistor that is approximately equivalent to the load presented by the heater. For other temperature control devices, a combination of resistive and inductive (or capacitive) loads may be present. In some cases, temperature circuit simulator 650 also includes a circuit equivalent of the thermal sensor. Temperature circuit simulator 650 communicates with a controller 305 in a limited reuse assembly via one or more of the contacts depicted in FIG. 6A. While temperature circuit simulator 650 is depicted in FIG. 6B as interfacing with contact 635, temperature circuit simulator 650 interfaces with any two of the contacts (631, 632, 633, 634, 635, 636) depicted in FIG. 6A.

Mechanical linkage interface sensor 655 is designed to determine whether the mechanical linkage interface 545 is functioning correctly. Mechanical linkage interface sensor 655 includes a linear transducer, proximity switch or other device that can detect the movement of mechanical linkage interface 545. Mechanical linkage interface 545 can travel into recess 630. When mechanical linkage interface sensor 655 is a proximity switch, the switch is activated when mechanical linkage interface 545 contacts it. In such a manner, mechanical linkage interface 545 can be activated and mechanical linkage interface sensor 655 can detect whether it moves properly. Mechanical linkage interface sensor 655 communicates with controller 305 in a limited reuse assembly via one or more of the contacts (631, 632, 633, 634, 635, 636) depicted in FIG. 6A.

In FIG. 6C, two limited reuse assemblies 250 are nested in a charging base 600. The two limited reuse assemblies 250 are nested in two different orientations. The first limited reuse assembly 250 is nested such that it is in a position to be tested by charging base 600. In this first position (the limited reuse assembly on the left hand side of FIG. 6C), mechanical linkage interface 545 interfaces with recess 630. Interface connector 525 interfaces with contact 632. While not depicted, some or all of the other connectors 551, 552, 553, 554, 557, and 556 that electrically link a limited reuse assembly to a tip segment, also interface with charging base 600. These connections can also serve to pass testing parameters between the controller 305 and the charging base 600. Such testing parameters may include parameters about the correct operation of limited reuse assembly 250. In the second position (the limited reuse assembly on the right hand side of FIG. 6C), limited reuse assembly 250 is being charged.

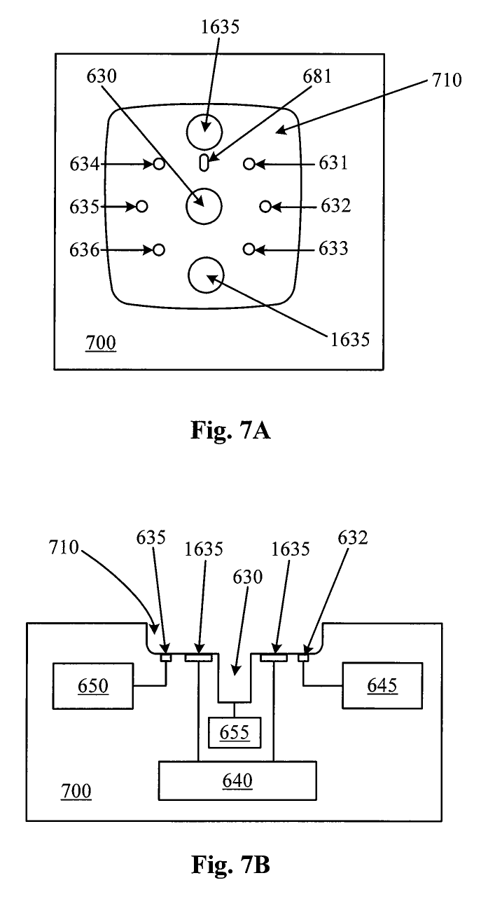

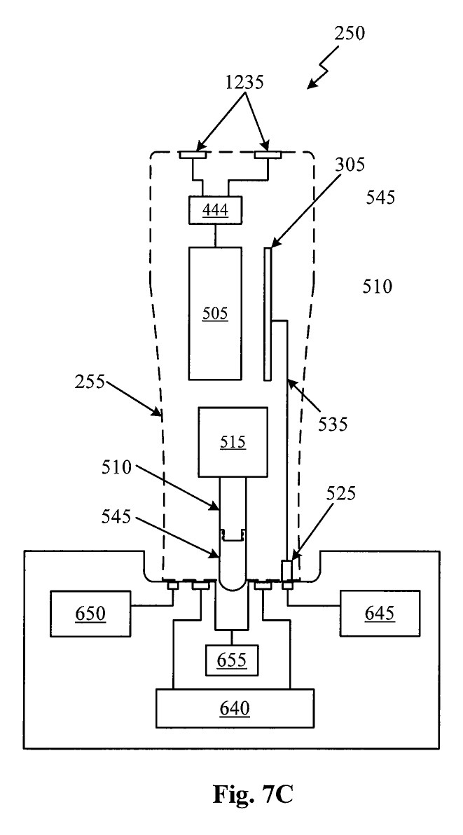

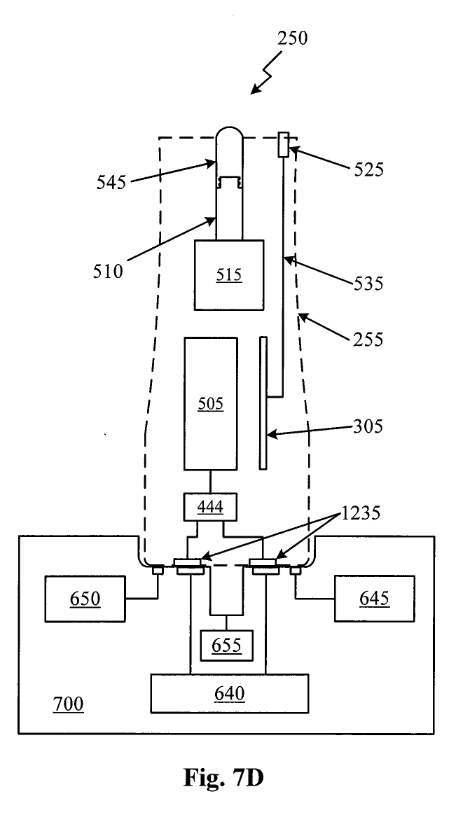

FIG. 7A is a top view of a charging base according to the principles of the present invention, FIG. 7B is a side cross section view of the charging base of FIG. 7A, FIG. 7C is a side cross section view of a limited reuse assembly nested in a testing configuration in the charging base of FIG. 7A, and FIG. 7D a side cross section view of a limited reuse assembly nested in a charging configuration in the charging base of FIG. 7A. The charging base 700 of FIGS. 7A-7C combines the two ports 610 and 620 depicted in FIGS. 6A-6C into a single port. In this manner, charging base 700 has one port 710 instead of two. The charging and testing functions of charging base 700 are combined into this single port 710. In this manner, either end of a limited reuse assembly can be placed in port 710. When placed as shown in FIG. 7C, limited reuse assembly 250 is ready to be tested as previously described with reference to FIGS. 6A-6C. When placed as shown in FIG. 7D, limited reuse assembly 250 is ready to be charged as previously described with reference to FIGS. 6A-6C. The testing and charging functions previously described apply to the embodiment of FIGS. 7A-7D. The difference is that a single port accommodates both the testing and charging functions. A user simply orients the limited reuse assembly 250 to allow the charging base 700 to perform the desired function.

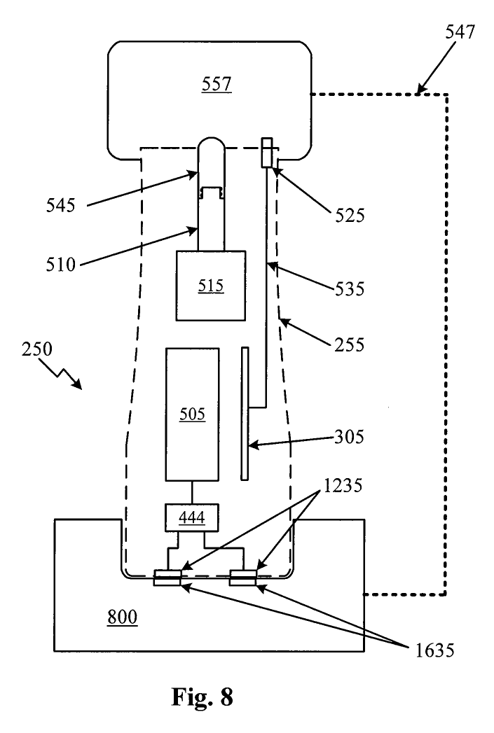

FIG. 8 is a cross section view of a limited reuse assembly nested in a charging base according to the principles of the present invention. In FIG. 8, a hood 557 is a part of or interfaces with the charging base 800. The testing functions, circuits, and structures previously described are present in hood 557. Hood 557 interfaces with charging base 800 via interface 547. Interface 547 may be a wired or wireless link. In addition, other physical structures may couple hood 557 to charging base 800. In the embodiment of FIG. 8, limited reuse assembly 250 is interfaced with a charging port and a testing port at the same time. In this configuration, the testing port is located opposite the charging port.

From the above, it may be appreciated that the present invention provides an improved system and method for monitoring and maintaining a power source for use with a medical device. The present invention provides a charging base and associated circuitry for monitoring the condition of a power source for the safe operation of a medical device. The present invention is illustrated herein by example, and various modifications may be made by a person of ordinary skill in the art.

While described in terms of an ophthalmic injection device, the present invention is suitable for use with any type of battery powered device. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A charging base for a battery-operated medical device comprising:
a testing port, the testing port having a recess and a plurality of contacts;
a fuse simulator coupled to at least one of the plurality of contacts;
a temperature simulator circuit coupled to at least one of the plurality of contacts; and
a mechanical linkage interface sensor located near the recess;
a charging port, the charging port having a charging connection;
charging circuitry located near the charging port; and
a housing at least partially enclosing the charging circuitry, fuse simulator, temperature simulator circuit, and mechanical linkage interface sensor.

2. The charging base of claim 1 wherein the first and second ports have different shapes.

3. The charging base of claim 1 wherein the first and second ports have different sizes.

4. The charging base of claim 1 wherein a first, interfacing end of a limited reuse assembly is nestable in the testing port and a second, charging end of the limited reuse assembly is nestable in the charging port.

5. The charging base of claim 1 wherein the fuse simulator is a switch.

6. The charging base of claim 1 wherein the temperature simulator circuit is a circuit equivalent of a temperature control device and a thermal sensor.

7. The charging base of claim 1 wherein the mechanical linkage interface sensor is a sensor capable of detecting movement of a mechanical linkage interface.

8. The charging base of claim 1 wherein the charging circuitry further comprises an AC to DC converter suitable for charging a rechargeable battery.

9. The charging base of claim 1 wherein the charging circuitry further comprises a coil for magnetically coupling with a coil located on a charging end of a limited reuse assembly, the magnetic coupling forming the charging connection.

10. The charging base of claim 1 wherein the contacts facilitate communication between the charging base and a limited reuse assembly nested in the testing port.

11. The charging base of claim 1 wherein the charging port and testing port are located adjacent to each other.

12. The charging base of claim 1 wherein the testing port is located in a hood located opposite the charging port.

13. A charging base for a battery-operated device comprising:
a port, the port having a plurality of contacts and a charging connection;
testing circuitry coupled to the plurality of contacts;
charging circuitry facilitating the charging connection; and
a housing at least partially enclosing the testing circuitry and the charging circuitry.

14. The charging base of claim 13 wherein the testing circuitry further comprises:
a fuse simulator coupled to at least one of the plurality of contacts.

15. The charging base of claim 13 wherein the testing circuitry further comprises:
a temperature simulator circuit coupled to at least one of the plurality of contacts.

16. The charging base of claim 13 wherein the testing circuitry further comprises:
a mechanical linkage interface sensor located near a recess in the port.

17. The charging base of claim 13 wherein a first, interfacing end of a limited reuse assembly is nestable in the port and a second, charging end of the limited reuse assembly is also nestable in the port.

18. The charging base of claim 14 wherein the fuse simulator is a switch.

19. The charging base of claim 15 wherein the temperature simulator circuit is a circuit equivalent of a temperature control device and a thermal sensor.

20. The charging base of claim 16 wherein the mechanical linkage interface sensor is a sensor capable of detecting movement of a mechanical linkage interface.

21. The charging base of claim 13 wherein the charging circuitry further comprises an AC to DC converter suitable for charging a rechargeable battery.

22. The charging base of claim 13 wherein the charging circuitry further comprises a coil for magnetically coupling with a coil located on a charging end of a limited reuse assembly, the magnetic coupling forming the charging connection.

23. The charging base of claim 13 wherein the contacts facilitate communication between the charging base and a limited reuse assembly nested in the port.
